(19) United States
(12) Patent Application Publication
(10) Pub. No.: US 2026/0210408 A1
(43) Pub. Date: Jul. 23, 2026

(54) IMPROVED FILTERING PULLEY

(71) Applicant: MUVIQ S.R.L., Ivrea (IT)

(72) Inventors: Andrea GUALA, Ivrea (IT); Gilberto DELLE ROSE, Ivrea (IT); Gianluca CARICCIA, Ivrea (IT)

(73) Assignee: MUVIQ S.R.L., Ivrea, TO (IT)

(21) Appl. No.: 19/141,483

(22) PCT Filed: Dec. 19, 2023
(86) PCT No.: PCT/IB2023/062913

§ 371 Date: Jun. 20, 2025

(30) Foreign Application Priority Data
Dec. 21, 2022 (IT) 102022000026352

(51) Int. Cl. F16D 3/12; F16D 3/66

(52) U.S. Cl. CPC F16D 3/12; F16D 3/66

(57) ABSTRACT

A filtering pulley has a hub adapted to be fixed to a shaft rotating around an axis (A), a crown mounted coaxially and rotationally free on the hub and a filtering unit operatively interposed between the hub and the crown. The hub has a first portion and a second portion, with the first portion being radially encompassed around the axis (A) by the crown, and with the second portion being only partially radially encompassed around the axis (A) by the crown. The filtering unit is operatively interposed between the hub and the crown around the first portion of the hub and axially facing the crown.

### CROSS-REFERENCE TO RELATED APPLICATIONS

This Patent Application claims priority from Italian Patent Application No. 102022000026352 filed on Dec. 21, 2022, the entire disclosure of which is incorporated herein by reference.

### TECHNICAL FIELD

The present invention relates to a filtering pulley.

The present invention finds its preferred, though not exclusive, application in vehicle engine systems. This application will be referred to hereinafter by way of example.

### STATE OF THE PRIOR ART

Electric machines in combination with or as a replacement for the internal combustion engine are increasingly used in order to reduce vehicle pollution and comply with the requirements of national regulations in terms of vehicle emission standards.

In a configuration known in the sector as “P0”, an electric machine is connected to the crankshaft of an internal combustion engine and operates in the so-called Belt Starting Generator (BSG) mode.

In such systems it is useful to use a filtering pulley between the electric machine and the accessory drive belt for driving the alternator.

In known configurations, this pulley comprises a hub suitable for being connected to the rotor of the alternator, an annular crown provided with a profile suitable for cooperating with the belt, and a filtering unit interposed between the hub and the pulley crown to avoid subjecting the belt to dynamic overloads in the presence of torsional vibrations of the drive shaft or rapid changes in engine speed.

The filtering unit usually comprises a spring, such as a helical or spiral spring, or a plurality of springs or other elastic elements arranged circumferentially between the hub and the crown.

However, this configuration limits the transmissible torque between the hub and the crown, which in some configurations can reach 50-75 Nm.

Therefore, there is a need to provide filtering pulleys for electric machines mounted in different vehicle configurations, which allow the torque to be transmitted over a wide operating range.

The object of the present invention is to meet the above requirements in an optimized and cost-effective manner.

### SUMMARY OF THE INVENTION

Said object is achieved by means of a filtering pulley as claimed in the appended claims.

### BRIEF DESCRIPTION OF THE DRAWINGS

For a better understanding of the present invention, a preferred embodiment is described below by way of non-limiting example and with reference to the accompanying drawings, wherein:

FIG. 1 is a perspective view of a pulley according to the invention;

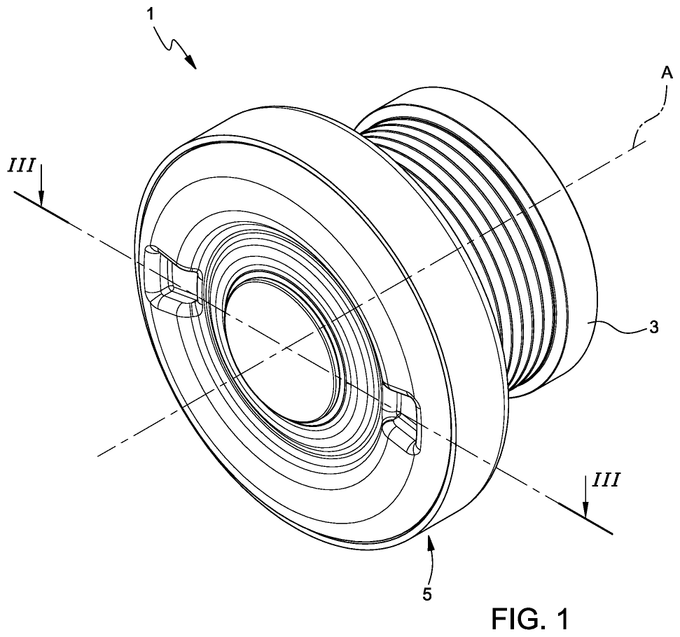

FIG. 2 is an exploded perspective view of the pulley in FIG. 1 along its longitudinal axis;

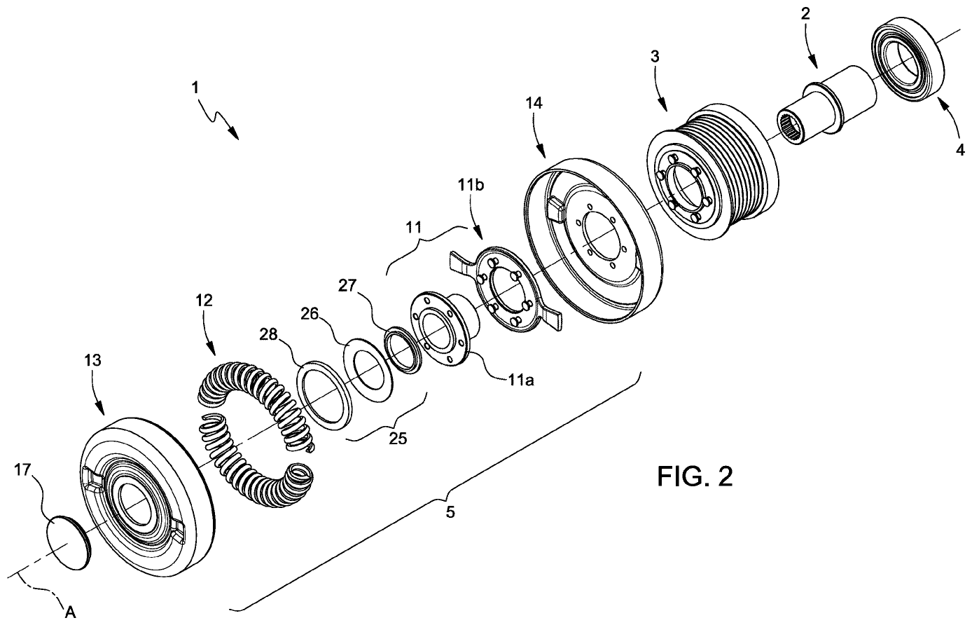

FIG. 3 is a sectional view along the line III-III in FIG. 1; and

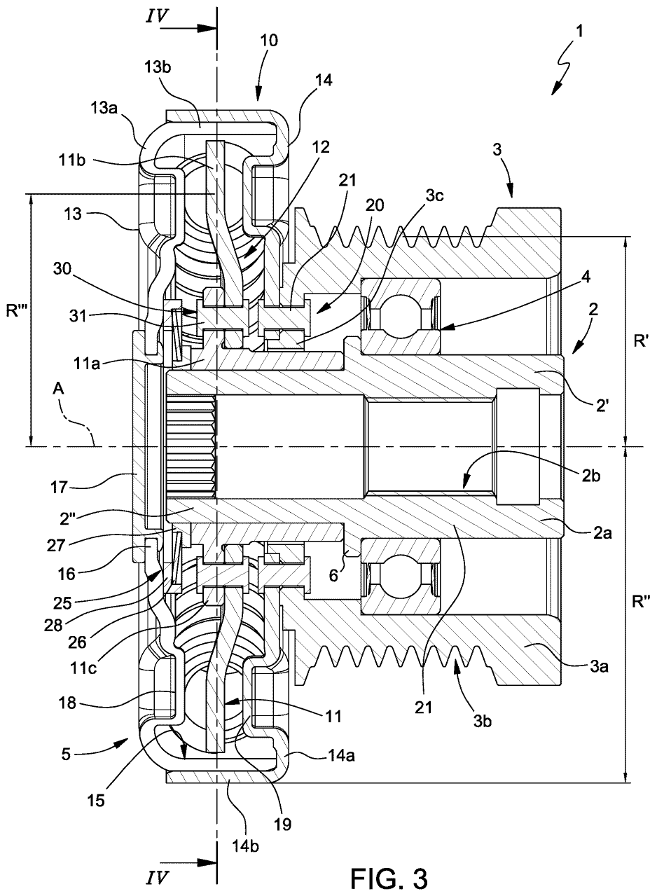

FIG. 4 is a sectional view along the line IV-IV in FIG. 3.

### DETAILED DESCRIPTION OF THE INVENTION

With reference to the attached figures, a pulley 1 is shown, which essentially consists of a hub 2, preferably tubular, a crown 3, preferably tubular, externally coaxial with the hub 2 and rotationally freely supported on the latter by support means 4, and a filtering unit 5 operatively interposed between the hub 2 and the crown 3 for the transmission of the torque.

The hub 2 and the crown 3 are coaxial around a longitudinal axis A coincident with the axis of an operating shaft of an electric machine (not shown).

In particular, the hub 2 comprises a cylindrical, advantageously tubular, portion 2a internally defining a coupling portion 2b for coupling to the aforementioned operating shaft.

The crown 3 essentially comprises a hollow, cylindrical portion 3a sized to radially house the hub 2 on the inside. The crown 3 has, on the side opposite the hub 2, a profile 3b with multiple grooves suitable for cooperating with a belt, e.g., a poly-V belt.

In particular, the aforementioned support means 4 comprise a rolling bearing, for example a ball bearing, radially interposed between the crown 3 and the hub 2.

In particular, the hub 2 is divided into a first end portion 2′ and a second end portion 2″ separated from each other by a radial flange 6 extending radially from the hub 2 towards the crown 3 and configured to act as a shoulder for the aforementioned rolling bearing. Accordingly, the crown 3 also defines a shoulder radially coincident with the radial flange 6 and designed to act as a shoulder for the aforementioned rolling bearing.

Advantageously, the support means 4 are placed radially to coincide with the profile 3b with multiple grooves, in more detail centred on it. Advantageously, the rolling bearing is placed symmetrically to the profile 3b, i.e., the centre of the rolling balls coincides with the axis of symmetry of the profile 3b.

In particular, the first end portion 2′ is internally radially surrounded by the hub 2 along the axis A and faces the electric machine, whereas the second end portion 2″ is only partially radially surrounded by the hub 3 along the axis A and supports the filtering unit 5.

The filtering unit 5 is therefore supported axially facing the crown 3 outside the space radially comprised between the crown 3 and the hub 2, which only houses the support means 4.

The filtering unit 5 essentially comprises a housing 10 integrally carried by one of the hub 2 and the crown 3, an actuator 11 integrally carried by the other of the hub 2 and the crown 3, and elastic means 12 operatively interposed between the housing 10 and the actuator 11, as described in detail below.

For the sake of simplicity, the configuration shown in which the housing 10 is integral with the crown 3 and the actuator 11 is integral with the hub 2 will be described, it being clear that this description is not intended to be limiting.

The housing 10 essentially comprises a first and a second element 13, 14 coupled to each other to isolate a space 15 from the external environment. Advantageously, the space 15 comprises on the inside a lubricant, such as grease.

In the embodiment shown, the first and the second element 13, 14 are cup-shaped, i.e., each comprising a respective wall 13a, 14a radial to the axis A and an axial wall 13b, 14b extending from an external radial portion of the respective radial wall 13a, 14a.

In particular, the first and the second element 13, 14 are sized so that they are rigidly connected to each other by contact, in particular so that the axial walls 13b, 14b are radially contained one within the other under pressure, thus keeping the first and the second element 13, 14 connected.

In particular, the second element 14 is rigidly connected to the crown 3, as described below. On the other hand, the second element 13 defines an opening 16 configured to house a cap 17. Advantageously, the opening 16 is coaxial with the axis A.

In particular, the second element 14 is rigidly connected to the crown 3 via a reversible mechanical connection 20, e.g., via threaded elements or rivets 21 or other form-fit coupling.

In detail, the crown 3 comprises a radial portion 3c extending from one end of the cylindrical portion 3a facing the filtering unit towards the hub 2. The radial portion 3c and the axial wall 14a of the second element 14 define respective openings configured to house the reversible mechanical connection 20.

Lastly, the closing element 11 comprises two projections 18, which are diametrically opposite relative to the axis A in the circumferential direction and axially extend within the chamber 15 from the axial wall 13a of the first element 13. Two additional projections 19, preferably arranged facing the projections 18, are provided on the wall 14a of the second element 14. The projections 18 and 19 are fixedly carried by the respective walls or, alternatively, made in one piece therewith.

Therefore, the projections 18, 19 divide the space 15 into two circumferentially opposite portions in which the elastic means 12 are housed.

The elastic means 12 advantageously comprise an elastic assembly for each portion of the space 15, arranged circumferentially free in the latter between the projections 18 and 19. Each of the elastic assemblies comprises at least one spring, in this case a helical and arched spring mounted between the above-mentioned projections 18, 19.

In the embodiment described, the springs are carried freely and without a free angle of circumferential movement between the projections 18, 19 and the spring itself. Clearly, a circumferential free angle between the springs and the respective projection may be provided or, on the contrary, the springs may be pre-compressed between the projections 18, 19. Furthermore, the springs can be in greater numbers per elastic assembly, placed in series or in parallel to each other and optionally accommodated in a spring holder.

The actuator 11 cooperates with the elastic means 12 and essentially comprises a hub portion 11a rigidly carried by the hub 2, and a plurality of spokes 11b radially extending from the hub portion 11a and cooperating in contact with the elastic means 12.

Advantageously, the hub portion 11a is carried by the hub 2 via a contact coupling, in particular it is pressed onto the hub 2, substantially cylindrical and housed in the second portion 2″ of the hub 2.

In detail, the spokes 11b are connected to the hub 11a via a reversible mechanical connection 30, e.g., via threaded elements or rivets 31 or other form-fit coupling.

In particular, the hub portion 11a defines a flange 11c extending radially from the hub portion 11a relative to the axis A. The flange 11c and the spokes 11b define respective openings configured to house the reversible mechanical connection 30.

Advantageously, the openings housing the reversible mechanical connection 30 between the spokes 11b and the hub portion 11a and the mechanical connection 20 between the second element 14 and the crown 3 are coaxial with each other along an axis parallel to the axis A. Even more preferably, they are substantially coaxial with the support means 4, in particular with the centre of the ball of the rolling bearings described herein, i.e., at the same radial distance from the axis A.

In particular, the flange 11c and the radial wall 3c are therefore parallel to each other and spaced apart along the axis A. In particular, the spokes 11b are axially placed between the radial wall 3c and the flange 11c.

As mentioned above, the spokes 11b cooperate in contact with the elastic means 12 as they are axially between the projections 18, 19 and free to move circumferentially around the axis A, cooperating with their own ends with the elastic assemblies of the elastic means.

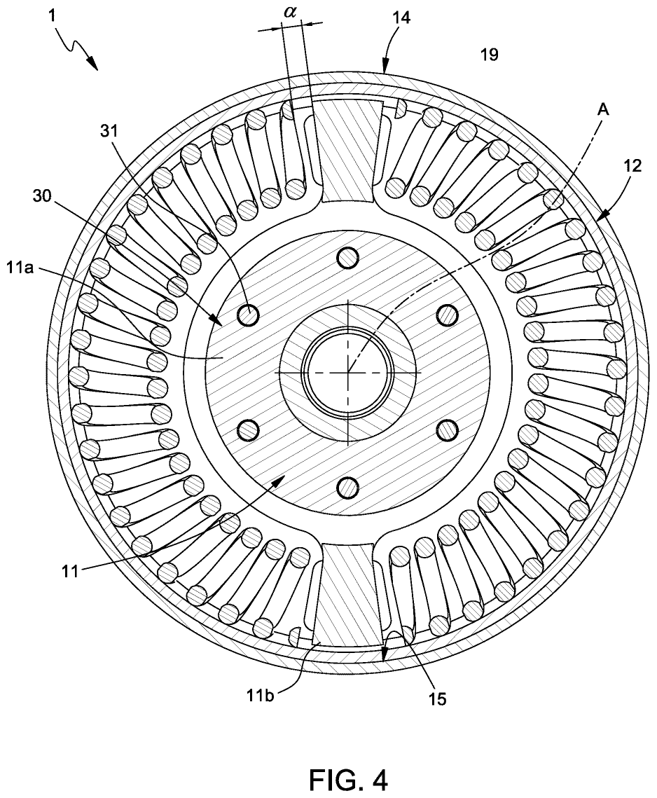

As shown in FIG. 4, in the embodiment described, an angular play a is present between each spoke 11b and the elastic means 12. Clearly, this angular play & can have a different amplitude or be absent. If the aforementioned play is present between the elastic means 12 and the projections 18, 19, this adds to the aforementioned angular play a.

The filtering unit 5 further comprises damping means 25 configured to provide damping between the hub 2 and the crown 3 when they move relative to each other. Advantageously, the damping means 25 are housed within the space 15, and hence isolated from the external environment.

In particular, the damping means 25 comprise an elastic element 26 operatively interposed between the hub portion 11a of the actuator 11 and the radial wall 13a of the first element 13. Advantageously, the elastic element 26 is a cup spring or a Belleville washer.

The damping means 25 advantageously comprise a pair of rings 27, 28 configured to support therebetween the elastic element 26. In detail, the first ring 27 is fitted on the hub 2 in axial contact with the hub portion 11b of the actuator 11, whereas the second ring 28 is carried in axial contact with the radial wall 13a of the first element 13, near the opening 16.

Advantageously, at least the second ring 28 is configured as a dust protection ring. Accordingly, the damping means 25 also have an insulating function for the space 15.

In addition to the above, it is noted that the average diameter R′ of the poly-V portion 3b of the crown 3 is smaller than the average actuation diameter R″ of the spokes 11b, which in turn is smaller than the maximum diameter R′″ of the housing 10.

In detail, the average diameter R′ refers to the average height of the profile of the poly-V portion 3b, the average actuation diameter R″ refers to the midpoint in the radial direction of the portion where the spokes 11b and the elastic means 12 contact each other, and clearly the maximum diameter R″ of the housing 10 is the maximum radial extension of the latter.

The operation of the above-described embodiment of the filtering pulley according to the invention is as follows.

In a first operating phase, called “Boost Motoring mode” when the electric machine works as an electric motor, the speed of the hub 2 tends to exceed the speed of the crown 3. For this reason, the spokes 11b of the actuator 11 transmit the torque to the projections 18, 19 with the interposition of the elastic means 12.

The above occurs, symmetrically, in the “Generator o Recuperation mode” condition, i.e., when the speed of the crown 3 tends to exceed the speed of the hub 2, i.e., when torque is supplied to the electric machine operating as a generator.

The advantages of a filtering pulley according to the invention are clear from the foregoing.

Since the filtering unit 5 can be externally connected between the hub 2 and the crown 3, it is possible to supply different filtering units 5 of different sizes optimized to the required filtering capacity, without having to modify the hub 2 and the crown 3.

In particular, the filtering unit 5 is defined in a housing made of easy-to-manufacture cup elements that can be connected to the crown 3/hub 2 by means of equally economical mechanisms. Therefore, the manufacturing and the installation of the filtering unit 5 are economical.

Furthermore, the size of the housing 10 and the size of the elastic means may vary according to the required transmissible torques and, as they can be expanded radially beyond the crown 3, the elastic means 12 can provide adequate torque transmission capacity and related filtering.

As a result of the above, the axial dimensions of known pulleys can be significantly reduced as it is not necessary to radially interpose the filtering unit between the hub and the crown, as is known in the art.

The use of reversible mechanical connections such as threaded elements or rivets or other form-fit couplings between the housing 10 and the crown 30 or between the elements of the actuator 11 allows easy assembly and disassembly in the case of inspection and maintenance.

The use of a damping system 25 provides a damping torque which improves the filtering capabilities and is easily adjustable according to the type of elastic element used.

The particular relative arrangement of reversible mechanical elements such as threaded elements or rivets between the housing 10 and the crown 30 or between the elements of the actuator 11 also increases the strength of the system by reducing the overturning moments. This advantage is also supported by the position of the support means 4.

Furthermore, the housing of the damping means 25 within the space 15 prevents contamination by and exposure to agents that may adversely affect the service life of the damping means, whose service life is therefore increased.

Lastly, it is clear that modifications and variations may be made to the filtering pulley according to the present invention, without however departing from the scope of protection defined by the claims.

For example, the support means could be replaced by a bushing, or the housing could be made in a different way or in a different shape.

As mentioned, the elastic elements may include different types of springs and in various numbers. Similarly, the damping means or the mechanical connections described herein could be of a different type.

1. A filtering pulley comprising:
a hub adapted to be fixed to a shaft rotating around an axis (A),
a crown mounted coaxially and rotationally free on said hub, and
a filtering unit operatively interposed between said hub and said crown,
wherein said hub comprising a first portion and a second portion, said first portion being radially comprised around said axis (A) by said crown, and said second portion being only partially radially comprised around said axis (A) by said crown,
wherein said filtering unit is operatively interposed between said hub and said crown around said second portion of the hub and axially facing said crown, said filtering unit comprises:
a housing connected, integrally with the rotation, to one of said hub and said crown, and
an actuator connected, integrally with the rotation, to the other one of said hub and said crown,
wherein said housing defining a space to house elastic means operatively interposed between said actuator and said crown,
wherein said housing comprises a first and a second element connected to each other to define said space and to said one of said hub and said crown, said first and said second element bearing respective stop elements extending into said space and dividing said space into several portions, where each portion houses said elastic means, said elastic means being operatively interposed in contact between said actuator and said stop elements, and
wherein one of said first and second elements is connected to one of said hub and said crown by means of a mechanical connection, said mechanical connection comprising a threaded, riveted or shaped connection.

2. The pulley according to claim 1, wherein said elastic means comprise at least one helical spring.

3. The pulley according to claim 1, wherein said elastic means are placed between said hub and said crown or with an angular play (α) for free sliding between said actuator and said housing or in contact between said actuator and said housing.

4. The pulley according to claim 1, wherein said elastic means are placed between said stop elements either with an angular play of free sliding relative to one another or in contact with each other.

5. The pulley according to claim 1, wherein said actuator comprises a hub portion carried by said second end of said hub and a plurality of spokes configured to cooperate in contact with said elastic means, said plurality of spokes being connected to said hub portion via a mechanical connection.

6. The pulley according to claim from 1, wherein said first and second elements are planted one radially inside the other.

7. The pulley according to claim 1, comprising damping means located in said space and operatively interposed between said housing and the other of said hub and said crown, said damping means being configured to provide a damping between said housing and the other of said hub and said crown depending on the relative rotation of the latter.

8. The pulley according to claim 7, wherein said damping means comprise an elastic element and a pair of rings connected to said elastic element respectively cooperating in contact with said housing and the other of said hub and said crown.

9. The pulley according to claim 8, wherein at least one of said rings is a dust guard lip.

10. The pulley according to claim 1, wherein said housing defines an opening configured to house a cap.
